(19) United States
(12) Patent Application Publication
(10) Pub. No.: US 2013/0272575 A1
(43) Pub. Date: Oct. 17, 2013

(54) OBJECT DETECTION USING EXTENDED SURF FEATURES

(71) Applicants: Jianguo Li, Beijing (CN); Yimin Zhang, Beijing (CN)

(72) Inventors: Jianguo Li, Beijing (CN); Yimin Zhang, Beijing (CN)

(73) Assignee: INTEL CORPORATION, Santa Clara, CA (US)

(21) Appl. No.: 13/977,137

(22) PCT Filed: Nov. 1, 2011
(86) PCT No.: PCT/CN2011/081642

§ 371 Date: Jun. 28, 2013

(51) Int. Cl. G06K 9/62

(52) U.S. Cl. CPC G06K 9/6217
USPC 382/103; 382/195

(57) ABSTRACT

Systems, apparatus and methods are described including generating gradient images from an input image, where the gradient images include gradient images created using 2D filter kernels. Feature descriptors are then generated from the gradient images and object detection performed by applying the descriptors to a boosting cascade classifier that includes logistic regression base classifiers.

### BACKGROUND

Object detection aims to locate where (usually in terms of a particular rectangular region) a target object (such as human face, human body, automobile, and so forth) appears in a given image or video frame. In general, there are two major goals for object detection technology. First, the technology should minimize false-positive detection events where an object is detected in regions where there is no target object. For an object detection technology to have practical application there should be no more than one false-positive detection event for every one million regions tested. In other words, an optimal object detector's false-positive-per-detecting-window (FPPW) factor may be as small as 1×10⁻⁶. Second, the technology should provide true detection for almost all regions where a target object exists. In other words, an optimal object detector's hit-rate should be as close as possible to 100%. In practice, the final goal in object detection should be to come as close as possible to these benchmarks.

Conventional approaches to object detection technology usually employ boosting Haar cascade techniques in an attempt to achieve the benchmarks outlined above. However, such techniques typically involve long cascades of boosted classifiers based on one-dimensional (1D) Haar-like features and use decision trees to provide base classifiers. What are needed are more accurate and rapid techniques for object detection.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example object detection system;

FIG. 2 illustrates several example filter kernels:

FIG. 3 illustrates an example local region of an input image;

FIG. 4 is a flow chart of an example object detection process;

FIG. 5 illustrates an example integral image coordinate labeling scheme;

FIG. 6 is an illustrative diagram of an example boosting classifier cascade;

FIG. 7 illustrates example local regions of an image; and

FIG. 8 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access, memory (RAM); magnetic disk storage media, optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

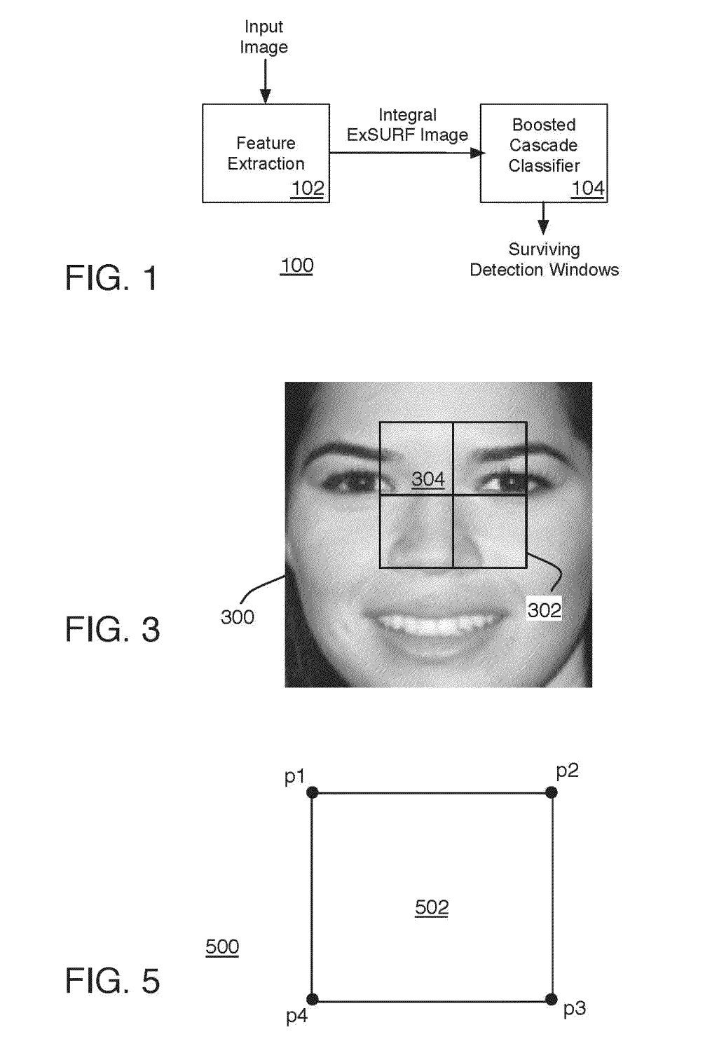

FIG. 1 illustrates an example system 100 in accordance with the present disclosure. In various implementations, system 100 may include a feature extraction module (FEM) 102, and a boosting cascade classifier module (BCCM) 104. As will be explained in greater detail below, FEM 102 may receive an input image and may extract features from the image. As will also be explained in greater detail below, the extracted features may then be subjected to processing by BCCM 104 to identify objects in the input image.

FEM 102 may employ known SURF (Speeded Up Robust Features) feature detection techniques (see, e.g., Bay et al., “Surf: Speeded up robust features,” Computer Vision and Image Understanding (CVIU), 110(3), pages 346-359, 2008) to generate descriptor features based on horizontal and vertical gradient images using a horizontal filter kernel of form [−1, 0, 1] to generate a horizontal gradient image (dx) from the input image, and a vertical filter kernel of form [−1, 0, 1]^{T} to generate a vertical gradient image (dy) from the input image. In standard SURF, two additional images may be generated corresponding to the absolute values |dx| and |dy| of the respective images dx and dy.

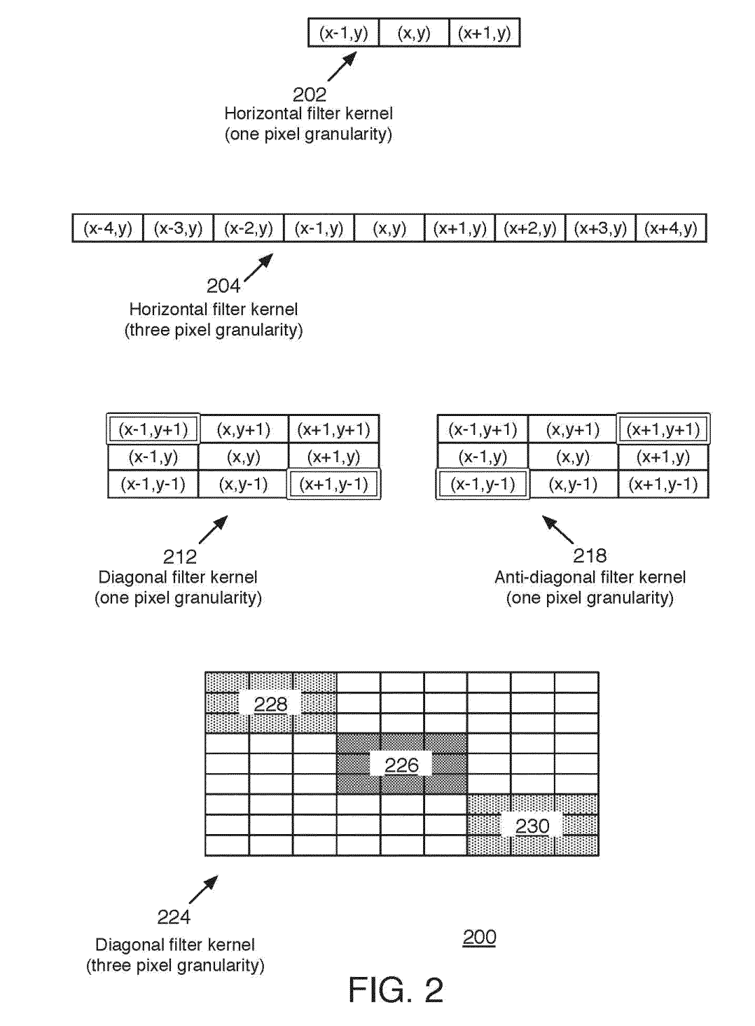

In various implementations, filter kernels in accordance with the present disclosure may have any granularity. For instance, FIG. 2 illustrates several example filter kernels 200 in accordance with the present disclosure. Kernels 200 include a 1D horizontal filter kernel 202 with one pixel granularity, a 1D horizontal filter kernel 204 with three pixel granularity, a 2D diagonal filter kernel 212 with one pixel granularity, a 2D anti-diagonal filter kernel 218 with one pixel granularity, and a 2D diagonal filter kernel 224 with three pixel granularity.

With regard to the example of FIG. 2, for a pixel location (x,y) in an image, horizontal filter kernel 202 may generate a gradient value d(x,y) according to

d(x,y)=I(x+1,y)−I(x−1,y) (1)
where I(x−1,y) is the value of the left-hand pixel position and I(x+1,y) is the value of the right-hand pixel position relative to pixel location (x,y). Horizontal filter kernel 204 (three pixel granularity) may generate a gradient value d(x,y) according to

$$\begin{matrix}d ( x , y ) = d ( x - 1 , y ) \\ = d ( x + 1 , y ) \\ = \{ I ( x + 2 , y ) + I ( x + 3 , y ) + I ( x + 4 , y ) ) - \\ ( I ( x - 2 , y ) + I ( x - 3 , y ) + I ( x - 4 , y ) \}\end{matrix} \qquad ( 2 )$$

In various implementations in accordance with the present disclosure, FEM 102 may also generate an Extended SURF (ExSURF) feature descriptor that builds upon the standard SURF features to include features generated using two-dimensional (2D) filter kernels. For instance, FEM 102 may generate extended descriptor features based on diagonal gradient images by applying a 2D main or lead-diagonal filter kernel (diag[−1 ,0,1]) to the input image to generate a lead-diagonal gradient image (du), and by applying a 2D anti-diagonal filter kernel (antidiag[1,0,−1]) to the input image to generate a anti-diagonal gradient image (dv).

For instance, referring again to example kernels 200 of FIG. 2, a diagonal filter kernel 212 (one pixel granularity) may generate a diagonal gradient value dᵤ(x,y) via

dᵤ(x,y)=I(x+1,y−1)−I(x−1,y+1) (3)
and for an anti-diagonal filter kernel 218 (three pixel granularity) an anti-diagonal gradient value dᵥ(x,y) may be provided by

dᵥ(x,y)=I(x+1,y+1)−I(x−1,y−1) (4)

Finally, for a three pixel granularity diagonal filter kernel 224 a diagonal gradient value for each of the nine pixel positions of region 226 may be provided by subtracting the summation of the value for the nine pixels of region 228 from the summation of the value for the nine pixels of region 230.

FEM 102 may generate two additional images corresponding to the absolute values |du| and |dv| of the respective images du and dv. Thus, for each input image subjected to ExSURF processing, FEM 102 may generate a total of eight gradient images: a horizontal gradient image (dx), an absolute value horizontal gradient image (|dx|), a vertical gradient image (dy), an absolute value vertical gradient image (|dy|), a diagonal gradient image (du), an absolute value diagonal gradient image (|du|), an anti-diagonal gradient image (dv), and an absolute value anti-diagonal gradient image (|dv|).

In accordance with the present disclosure, FEM 102 may use known integral image techniques (see, e.g., P. Viola and M. Jones, “Robust Real-Time Object Detection,” IEEE ICCV Workshop on Statistical and Computational Theories of Vision, 2001; hereinafter “Viola and Jones”) to generate eight integral gradient images corresponding to the eight gradient images. Based on the integral gradient images, an eight-dimensional ExSURF feature vector FV_{ExS} may be calculated for one spatial cell of an input image as the summation over all pixels within the cell as follows:

FV_{ExS}=(Σdx,Σdy,Σ|dx|,Σ|dy|,Σdu,Σdv,Σ|du|,Σ|dv|) (5)
For instance, FIG. 3 illustrates an example local region 302 in a portion 300 of an input image where local region 302 has been subdivided into a 2×2 array of spatial cells 304. The present disclosure is not limited, however, to particular sizes or shapes of local regions, and/or to particular sizes, shapes and/or number of spatial cells within a given local region. As will be explained in greater detail below, FEM 102 may generate an integral eight-channel array-of-structure ExSURF image from the eight integral gradient images and may provide the integral ExSURF image to BCM 104 and/or may store the integral ExSURF image in memory (not depicted in FIG. 1).

As will be explained in further detail below, in various implementations in accordance with the present disclosure, BCCM 104 may employ a boosting classifier cascade (BCC) of weak classifiers to various portions of the ExSURF image. Each stage of BCCM 104 may include a boosting ensemble of weak classifiers where each classifier may be associated with a different local region of the image. In various implementations, each weak classifier may be a logistic regression base classifier. For instance, for an eight-dimensional ExSURF feature x of a local region, an applied logistic regression model may define a probability model of a weak classifier f(x) for a stage as

$$f ( x ) = P ( y = \pm 1 \vert x , w ) = \frac{1}{1 + exp ( - yw \cdot x )} \qquad ( 6 )$$

where y is the label for the local region (e.g., positive if target, negative if no target) and w is the weight vector parameter of the model. In various implementations, BCCM 104 may use various BCCs employing different weak classifiers. Thus, in some non-limiting examples, BCCM 104 may employ a BCC having face detection classifiers to identify facial features in local regions, while in other implementations BCCM 104 may employ a BCC having vehicle detection classifiers to identify features corresponding to cars and other vehicles, and so forth.

In various implementations, FEM 102 and BCCM 104 may be provided by any computing device or system. For example, one or more processor cores of a microprocessor may provide FEM 102 and BCCM 104 in response to instructions generated by software. In general, any type of logic including hardware, software and/or firmware logic or any combination thereof may provide FEM 102 and BCCM 104.

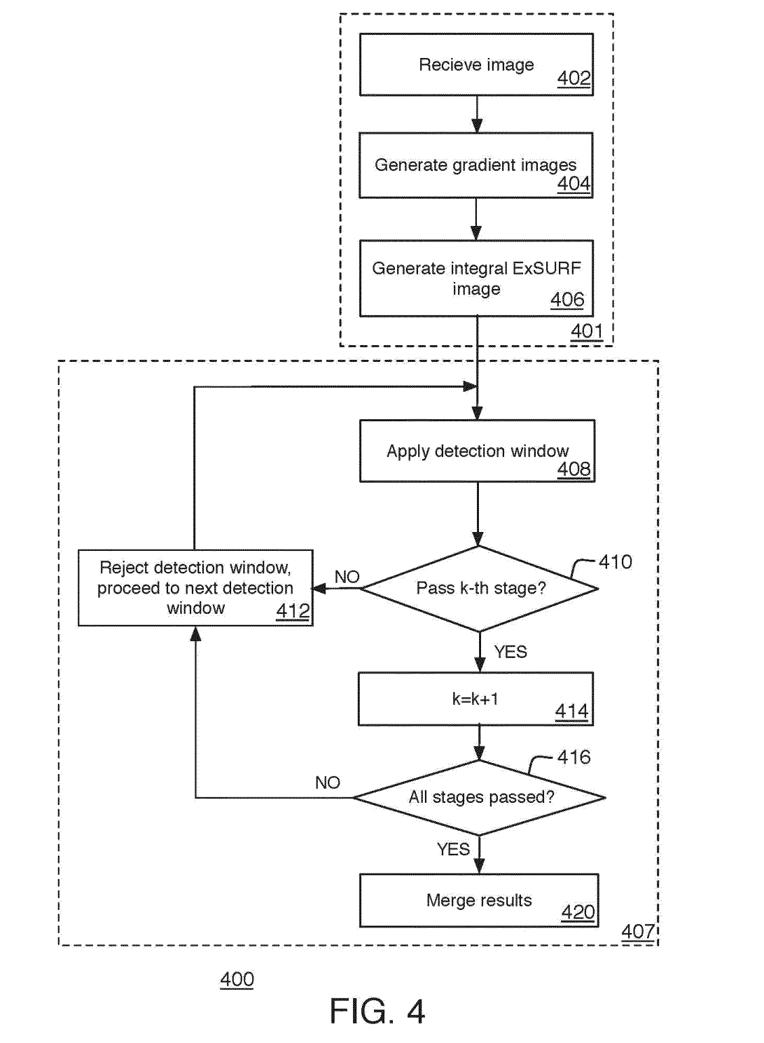

FIG. 4 illustrates a flow diagram of an example process 400 for object detection according to various implementations of the present disclosure. Process 400 may include one or more operations, functions or actions as illustrated by one or more of blocks 402, 404, 406, 408, 410, 412, 414, 416 and 420 of FIG. 4. Process 400 may include two sub-processes, a feature extraction sub-process 401 and a window scanning sub-process 407. By way of non-limiting example, process 400 will be described herein with reference to example system 100 of FIG. 1.

Process 400 may begin with the feature extraction sub-process 401 where, at block 402, an input image may be received. For example, block 402 may involve FEM 102 receiving an input image. In various implementations, the image received at block 402 may have been preprocessed. For example, the input image may have been subjected to strong gamma compression, center-surround filtering, robust local chain normalization, highlight suppression and the like.

At block 404, gradient images may be generated from the input image. In various implementations, block 404 may involve FEM 102 applying a set of 1D and 2D gradient filters including horizontal, vertical, lead-diagonal and anti-diagonal filter kernels to generate a total of eight gradient images dx, dy, |dx|, |dy|, du, dv, |du| and |dv| as described above. FEM 102 may then generate eight integral gradient images corresponding to the gradient images as described above.

At block 406, an integral ExSURF image may be generated. In various implementations, block 406 may involve FEM 102 using the integral gradient images to create an eight-channel integral ExSURF image using the following pseudo-code for or the integral ExSURF image's structure:

```
typedef struct
      {
            float dx, dy, absdx, absdy,
            float du, dv, absdu, absdv;
      }SURFAos;
SURFAos pImage[w*h]
where w and h are the integral ExSURF image width and height.
```

In various implementations, an integral ExSURF image may have the same size as an input image or a gradient image. For instance, suppose 1 is an input gradient image where I(x,y) is the pixel value at position (x, y). A point in the corresponding integral ExSURF image (SI), SI(x, y), may be defined as the summation of pixel values taken from the top-left pixel position of the image I to the position (x, y):

$$SI ( x , y ) = {\sum }_{j = 0}^{y} {\sum }_{i = 0}^{x} I ( i , j ) \qquad ( 7 )$$

Thus, once the integral ExSURF image is generated at block 406, ExSURF values for any given region or spatial cell of an image may be obtained by accessing four corresponding vertices in the integral ExSURF image. For example, FIG. 5 illustrates an example labeling scheme 500 for integral ExSURF image data where the ExSURF value for an image region or cell 502 may be found by accessing the feature vector values stored at the corresponding vertices p1, p2, p3 and p4 in the integral ExSURF image (e.g., SI(p1), SI(p2) and so forth). The eight-channel ExSURF value for cell 502 may then be provided by

SI_{cell}=SI(p3)+SI(p1)−SI(p2)−SI(p4) (8)

Thus, the conclusion of the feature extraction sub-process 401 (e.g., subsequent to block 406), may result in the generation of an integral ExSURF image as described above. Although not depicted FIG. 4, process 400 may include storing the integral ExSURF image for later processing (e.g., by window scanning sub-process 407). In various implementations, FEM 102 may undertake blocks 402-406 of feature extraction sub-process 401. After doing so, FEM 102 may store the resulting integral ExSURF image in memory (not depicted in FIG. 1) and/or may provide the integral ExSURF image to BCCM 104 for additional processing (e.g., by window scanning sub-process 407).

Process 400 may continue with the undertaking of window scanning sub-process 407, where, at block 408 a detection window may be applied. In various implementations, window scanning sub-process 407 may be undertaken by BCCM 104, and at block 408, BCCM 104 may apply a detection window to the integral ExSURF image (or a portion thereof) where BCCM 104 has obtained the integral ExSURF image (or a portion thereof) from FEM 102 or from memory (not depicted in FIG. 1).

In various implementations, window scanning sub-process 407 may involve an image scanning scheme including scanning all possible positions in an image using different sized detection windows. For example, a scaling detection template scheme may be applied for sub-process 407. For instance, if window scanning sub-process 407 is being undertaken to detect faces in an input image, an original detection window template may have a size of 40×40 pixels. This original detection window template may be scanned over the image to probe the corresponding detection window at each position with the classifier cascade. After scanning with 40×40 template is finished, the template size may be up-scaled by a factor (such as 1.2) to obtain a larger detection window (e.g., 48×48 pixels) that may then also be scanned across the image. This procedure may be repeated until the detection template reaches the size of the input image.

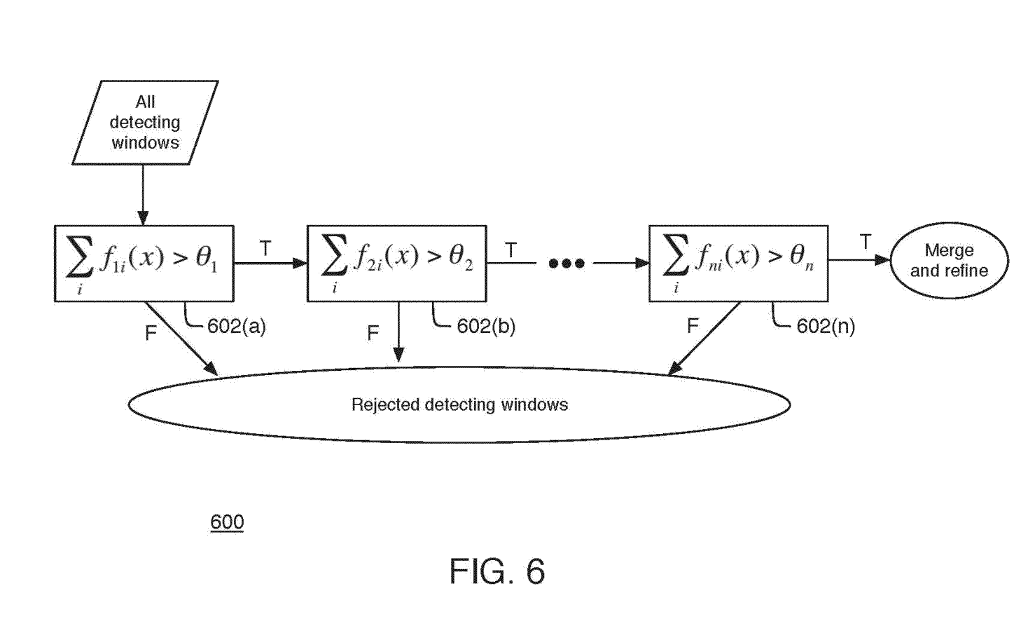

Block 408 may involve applying a BCC to the ExSURF feature vector values corresponding to the detection window. FIG. 6 illustrates an example BCC 600 according to various implementations of the present disclosure. BCC 600 includes multiple classifier stages 602(a), 602(b), . . . , 602(n), where each classifier stage includes one or more logistic regression base classifiers (see Eqn. (6)), and where each logistic regression base classifier corresponds to a local region within the detection window.

For example, considering a 48×48 face detection window, block 408 may involve applying the corresponding ExSURF image values to BCC 600. In this non-limiting example, the first stage 602(a) may include only one local, region (e.g., for fast filtering negative windows) such as an eye-region that may be tested against a threshold (θ) using the corresponding logistic regression base classifier f₁(x). The subsequent stages may have more than one local region selected and the judgment at each stage may be whether the summed result (of the output of every selected local region) is larger than the trained threshold (θ). For example, stage 602(b) may correspond to the summation of values for nose and mouth regions subjected to corresponding logistic regression base classifiers f₂₁(x) and f₂₂(x). In various implementations, local regions may be used in various different stages, and may have different parameters (such the weight parameter “w” or Eqn. (6)) in various stages.

In various implementations, the BCC applied at block 408 may have been previously trained using known cascade training techniques (see, e.g., Viola and Jones). For instance, given a detection window such as a 40×40 pixel face detection window rectangular local regions may be defined within the template. In various implementations, the local regions may overlap. Each local region may be specified as a quadruple (x, y, w, h) where (x,y) corresponds to the top-left corner point of the local region, and (w, h) are the width and height of the rectangle forming the local region. In various implementations, local regions may range from 16 pixels to 40 pixels in width or height, and the width-height ratio may have any value such as 1:1; 1:2, 2:1, 2:3, and so forth. In general, a detection window may encompass anywhere from one to several hundred local regions. For example, a 40×40 face detection template may include more than 300 local regions.

The cascade training may include, within each stage, using a known boosting algorithm such as the AdaBoost algorithm (see, e.g., Viola and Jones) applied to selected local regions from a given set of positive and negative sample training images. The stage threshold may then be determined by Receiver Operating Characteristic (ROC) analysis. After one stage has converged, false-alarm samples (which have passed previous stages but which are negative) may be collected as negative samples, and the classifier in a next stage may be trained with the positive samples and newly collected negative samples. During training each local region may be given a score based on the classification accuracy. Local regions have larger scores may then be selected for later use in process 400. The training procedure may be undertaken until the BCC reaches a desired accuracy (e.g., measured in terms of hit-rate and/or FPPW).

Continuing the discussion of FIG. 4 in the context of the example of FIG. 6, block 408 may include applying the ExSURF values to each stage of BCC 600. For example, ExSURF values for the detection window may first be applied to stage 602(a) of BCC 600. Block 410 may then involve determining whether the window's ExSURF values satisfy or pass the decision threshold of stage 602(a). If the window does not pass the first stage, then process may branch to block 412 where the detection window may be rejected (e.g., discarded as not corresponding to a detected object). Process 400 may then return to block 408 where a new detection window may be applied. For example, continuing the face detection example from above, if a first 48×48 window fails testing at first stage 602(a) (e.g., no eyes detected), then that window may be discarded and the 48×48 detection template may be scanned to a next position in the image and the resulting new 48×48 window may be processed at block 408.

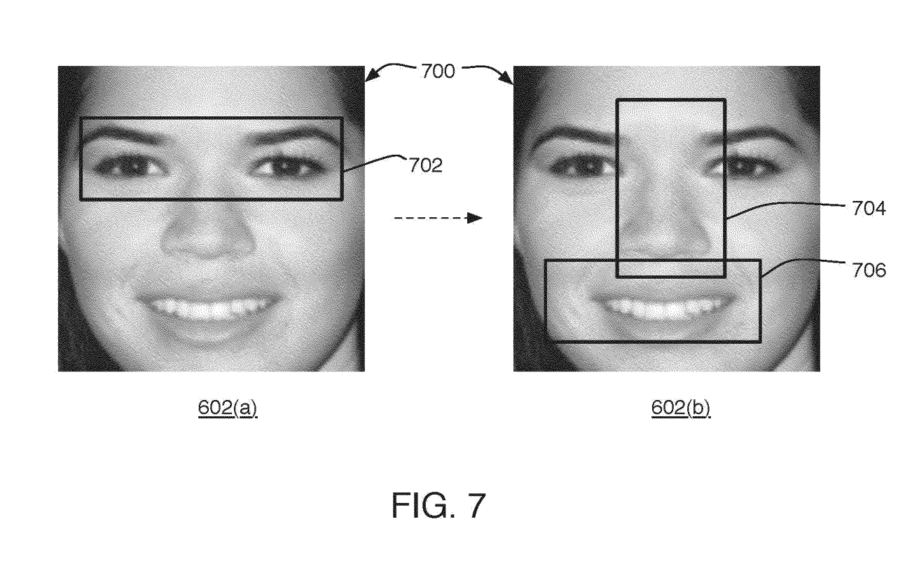

If however, the detection window passes the first stage, process may continue with application of a next stage (block 414). For example, having passed stage 602(a), the window's ExSURF values may be tested against stage 602(b). For example, continuing the face detection example, if the first 48×48 window passes testing at first stage 602(a) (eyes detected in a local region), then that window may be passed to stage 602(b) where the ExSURF values may be tested in different local regions corresponding to nose and mouth base classifiers. For instance, FIG. 7 illustrates an example detection window 700 where ExSURF values in a local region 702 are tested against a base classifier for eyes at stage 602(a), while (assuming window 700 passes testing at stage 602(a)) ExSURF values corresponding to local regions 704 and 706 are tested against respective nose and mouth base classifiers at stage 602(b), and so forth.

Thus, process 400 may continue with the application of the window's ExSURF values to even stage of BCC 600 until the window is rejected at a stage (and process 400 branches, back to block 408 via block 412) or until all stages have been determined to have been passed (block 416) at which point the results of the various stages are merged as a detected object (block 420) at which point sub-process 407 and process 400 may end.

While implementation of example process 400, as illustrated in FIG. 4, may include the undertaking of all blocks shown in the order illustrated, the present disclosure is not limited in this regard and, in various examples, implementation of process 400 may include the undertaking only a subset of the blocks shown and/or in a different order than illustrated.

In addition, any one or more of the sub-processes and/or blocks of FIG. 4 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including, one or more processor core(s) may undertake one or more of the blocks shown in FIG. 4 in response to instructions conveyed to the processor by a computer readable medium.

Object detection techniques in accordance with the present disclosure that use ExSURF feature vectors and logistic regression base classifiers provide improved results as compared to a Haar cascade techniques (see, e.g., Viola and Jones). Table 1 shows example execution times for these two methods for a face detector in C/C++ running on an X86 platform (Intel® core i7) using the CMU-MIT public dataset (containing 130 gray images including 507 frontal faces).

TABLE 1
Comparison of executive time performance

| | Num- | | Number | | | | |
|---|---|---|---|---|---|---|---|
| | ber | | of | | | | Frames |
| | of | | stages | | | Hit- | Per |
| | Fea- | | in | | | rate | Second |
| Method | tures | Classifier | cascade | Model size | | (%) | (FPS) |
| Haar cascade | 2912 | Decision | 24 | >1 | MB | 79.7 | 49 |
| | | tree | | | | | |
| Techniques | 334 | Logistic | 8 | ~60 | KB | 90.8 | 70 |
| in | | regression | | | | | |
| accordance | | | | | | | |
| with the | | | | | | | |
| present | | | | | | | |
| disclosure | | | | | | | |

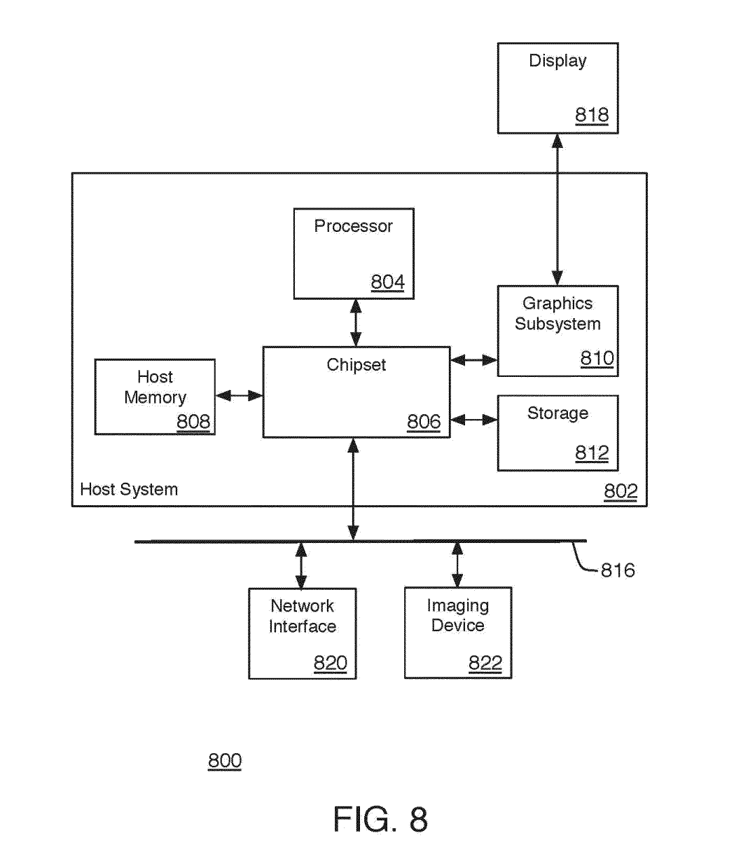

FIG. 8 illustrates an example computing system 800 in accordance with the present disclosure. System 800 may be used to perform some or all of the various functions discussed herein and may include any device or collection of devices capable of undertaking processes described herein in accordance with various implementations of the present disclosure. For example, system 800 may include selected components of a computing platform or device such as a desktop, mobile or tablet computer, a smart phone, a set top box, etc., although the present disclosure is not limited in this regard. In some implementations, system 800 may include a computing platform or SoC based on Intel® architecture (IA) in, for example, a CE device. It will be readily appreciated by one of skill in the art that the implementations described herein can be used with alternative processing systems without departure from the scope of the present disclosure.

Computer system 800 may include a host system 802, a bus 816, a display 818, a network interface 820, and an imaging device 822. Host system 802 may include a processor 804, a chipset 806, host memory 808, a graphics subsystem 810, and storage 812. Processor 804 may include one or more processor cores and may be any type of processor logic capable of executing software instructions and/or processing data signals. In various examples, processor 704 may include Complex Instruction Set Computer (CISC) processor cores, Reduced Instruction Set Computer (RISC) microprocessor cores, Very Long Instruction Word (VLIW) microprocessor cores, and/or any number of processor cores implementing any combination or types of instruction sets. In some implementations, processor 804 may be capable of digital signal processing and/or microcontroller processing.

Processor 804 may include decoder logic that may be used for decoding instructions received by, e.g., chipset 806 and/or a graphics subsystem 810, into control signals and/or microcode entry points. Further, in response to control signals and/or microcode entry points, chipset 806 and/or graphics subsystem 810 may perform corresponding operations. In various implementations, processor 804 may be configured to undertake any of the processes described herein including the example processes described with respect to FIG. 4.

Chipset 806 may provide intercommunication among processor 804, host memory 808, storage 812, graphics subsystem 810, and bus 816. For example, chipset 806 may include a storage adapter (not, depicted) capable of providing intercommunication with storage 812. For example, the storage adapter may be capable of communicating with storage 812 in conformance with any of a number of protocols, including, but not limited to, the Small Computer Systems Interface (SCSI), Fibre Channel (FC), and/or Serial Advanced Technology Attachment (S-ATA) protocols. In various implementations, chipset 805 may include logic capable of transferring information within host memory 808, or between network interface 820 and host memory 808, or in general between any set of components in system 800. In various implementations, chipset 806 may include more than one IC.

Host memory 808 may be implemented as a volatile memory device such as but not limited to a Random Access Memory (RAM) Dynamic Random Access Memory (DRAM), or Static RAM (SRAM) and so forth. Storage 812 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device or the like.

Memory 808 may store instructions and/or data represented by data signals that may be executed by processor 804 in undertaking any of the processes described herein including the example process described with respect to FIG. 4. For example, host memory 808 may store gradient images, integral ExSURF images and so forth. In some implementations, storage 812 may also store such items.

Graphics subsystem 810 may perform processing or images such as still or video images for display. For example, in some implementations, graphics subsystem 810 may perform video encoding or decoding of an input video signal. For example, graphics subsystem 810 may perform activities as described with regard to FIG. 4. An analog or digital interface may be used to communicatively couple graphics subsystem 810 and display 818. For example, the interface ma be any of a High-Definition Multimedia Interface, DisplayPort, wireless HDMI, and/or wireless HD compliant techniques. In various implementations, graphics subsystem 810 may be integrated into processor 804 or chipset 806. In some other implementations, graphics subsystem 810 may be a stand-alone card communicatively coupled to chipset 806.

Bus 816 may provide intercommunication among at least host system 802, network interface 820, imaging device 822 as well as other peripheral devices (not depicted) such as a keyboard, Mouse, and the like. Bus 816 may support serial or parallel communications. Bus 816 may support node-to-node or node-to-multi-node communications. Bus 816 may at least be compatible with the Peripheral Component Interconnect (PCI) specification described for example at Peripheral Component Interconnect (PCI) Local Bus Specification, Revision 3.0, February 2, 2004 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.1, March 28, 2005, available from the aforesaid PCI Special Interest Group, Portland, Oreg., U.S.A. (as well as revisions thereof); and/or Universal Serial Bus (USB) (and related standards) as well as other interconnection standards.

Network interface 820 may be capable of providing intercommunication between host system 802 and a network in compliance with any applicable protocols such as wired or wireless techniques. For example, network interface 820 may comply with any variety of IEEE communications standards such as 802.3, 802.11, or 802.16. Network interface 820 may intercommunicate with host system 802 using bus 816. In some implementations, network interface 820 may be integrated into chipset 806.

The graphics and/or video processing techniques described herein may be implemented in various hardware architectures. For example, graphics and or video functionality may be integrated within a chipset. Alternatively, a discrete graphics and/or video processor may be used. As still another implementation, the graphics and/or video functions may be implemented by a general purpose processor, including a multi-core processor. In a further implementation, the functions may be implemented in a consumer electronics device.

Display 818 may be any type of display device and/or panel. For example, display 818 may be a Liquid Crystal Display (LCD), a Plasma Display Panel (PDP), an Organic Light Emitting Diode (OLED)) display, and so forth. In some implementations, display 818 may be a projection display (such as a pico projector display or the like), a micro display, etc. In various implementations, display 818 may be used to display input images that have been subjected to object detection processing as described herein.

Imaging device 822 may be any type of imaging device such as a digital camera, cell phone camera, infra red (IR) camera, and the like. Imaging device 822 may include one or more image sensors (such as a Charge-Coupled Device (CCD) or Complimentary Metal-Oxide Semiconductor (CMOS) image sensor). Imaging device 822 may capture color or monochrome images. Imaging device 822 may capture input images (still or video) and provide those images, via bus 816 and chipset 806, to processor 804 for object detection processing as described herein.

In some implementations, system 800 may communicate with various I/O devices not shown in FIG. 8 via an I/O bus (also not shown). Such I/O devices may include but are not limited to for example, a universal asynchronous receiver/transmitter (UART) device, a USB device, an I/O expansion interface or other I/O devices. In various implementations, system 800 may represent at least portions of a system for undertaking mobile, network and/or wireless communications.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1.-28. (canceled)

29. A computer-implemented method, comprising:
receiving an input image;
generating a plurality of gradient images of the input image, wherein the plurality of gradient images includes at least a first gradient image created using a two-dimensional filter kernel;
generating feature descriptors of the input image in response to the plurality of gradient images; and
performing object detection on the input image by applying a boosting cascade classifier to the feature descriptors, wherein the boosting cascade classifier includes a plurality of logistic regression base classifiers.

30. The method of claim 29, further comprising:
generating a plurality of integral images, each integral image corresponding to a separate one of the plurality of gradient images

31. The method of claim 30, wherein generating feature descriptors comprises generating a multi-channel integral image from the plurality of integral images.

32. The method of claim 31, wherein the plurality of integral images comprises eight integral images, and wherein the multi-channel integral image comprises an eight-channel integral image.

33. The method of claim 29, wherein the two-dimensional filter kernel comprises at least one of a diagonal gradient filter kernel or an anti-diagonal gradient filter kernel.

34. The method of claim 33, wherein the feature descriptors comprise feature vectors including at least one diagonal gradient feature.

35. The method of claim 34, wherein the feature vector includes at least a horizontal gradient value, a vertical gradient value, a lead-diagonal gradient value, and an anti-diagonal gradient value.

36. An article comprising a computer program product having stored therein instructions that, if executed, result in:
receiving an input image;
generating a plurality of gradient images of the input image, wherein the plurality of gradient images includes at least a first gradient image created using a two-dimensional filter kernel;
generating feature descriptors of the input image in response to the plurality of gradient images; and
performing object detection on the input image by applying a boosting cascade classifier to the feature descriptors, wherein the boosting cascade classifier includes a plurality of logistic regression base classifiers.

37. The article of claim 36, further comprising instructions that, if executed, result in:
generating a plurality of integral images, each integral image corresponding to a separate one of the plurality of gradient images

38. The article of claim 37, wherein generating feature descriptors comprises generating a multi-channel integral image from the plurality of integral images.

39. The article of claim 38, wherein the plurality of integral images comprises eight integral images, and wherein the multi-channel integral image comprises an eight-channel integral image.

40. The article of claim 36, wherein the two-dimensional filter kernel comprises at least one of a diagonal gradient filter kernel or an anti-diagonal gradient filter kernel.

41. An apparatus, comprising:
a processor configured to:
receive an input image;
generate a plurality of gradient images of the input image, wherein the plurality of gradient images includes at least a first gradient image created using a two-dimensional filter kernel;
generate feature descriptors of the input image in response to the plurality of gradient images; and
perform object detection on the input image by applying a boosting cascade classifier to the feature descriptors, wherein the boosting cascade classifier includes a plurality of logistic regression base classifiers.

42. The apparatus of claim 41, wherein the two-dimensional filter kernel comprises at least one of a diagonal gradient filter kernel or an anti-diagonal gradient filter kernel.

43. The apparatus of claim 42, wherein the feature descriptors comprise feature vectors including at least one diagonal gradient feature.

44. The apparatus of claim 43, wherein the feature vector includes at least a horizontal gradient value, a vertical gradient value, a lead-diagonal gradient value, and an anti-diagonal gradient value.

45. A system comprising:
an imaging device; and
a computer system, wherein the computer system is communicatively coupled to the imaging device and wherein the computer system is to:
receive an input image from the imaging device;
generate a plurality of gradient images of the input image, wherein the plurality of gradient images includes at least a first gradient image created using a two-dimensional filter kernel;
generate feature descriptors of the input image in response to the plurality of gradient images; and
perform object detection on the input image by applying a boosting cascade classifier to the feature descriptors, wherein the boosting cascade classifier includes a plurality of logistic regression base classifiers.

46. The system of claim 45, wherein the computer system is to:
generate a plurality of integral images, each integral image corresponding to a separate one of the plurality of gradient images

47. The system of claim 46, wherein to generate feature descriptors the computer system is to generate a multi-channel integral image from the plurality of integral images.

48. The system of claim 45, wherein the two-dimensional filter kernel comprises at least one of a diagonal gradient filter kernel or an anti-diagonal gradient filter kernel.

49. The system of claim 48, wherein the feature descriptors comprise feature vectors including at least one diagonal gradient feature.

50. The system of claim 49, wherein the feature vector includes at least a horizontal gradient value, a vertical gradient value, a lead-diagonal gradient value, and an anti-diagonal gradient value.
